(19) United States
(12) Patent Application Publication
(10) Pub. No.: US 2022/0029788 A1
(43) Pub. Date: Jan. 27, 2022

(54) SYSTEMS AND METHODS FOR DATA MASKING AND AGGREGATION USING ONE-TIME PADS

(71) Applicant: Seagate Technology LLC, Fremont, CA (US)

(72) Inventor: Hamza Jeljeli, Singapore (SG)

(21) Appl. No.: 16/936,646

(22) Filed: Jul. 23, 2020

(51) Int. Cl. H04L 9/06; H04L 9/14

(52) U.S. Cl. CPC H04L 9/0662; G06F 7/582; H04L 9/14

(57) ABSTRACT

A method includes collecting a plurality of masked datasets. In certain embodiments, each masked dataset is associated with a one-time pad. The method can further include aggregating the plurality of masked datasets such that the one-time pads cancel each other to create an unmasked aggregated dataset.

### SUMMARY

In certain embodiments, a method for data masking and aggregation is disclosed. The method includes: collecting a plurality of masked datasets, each masked dataset associated with a respective one-time pad; and aggregating the plurality of masked datasets such that the one-time pads cancel each other to create an unmasked aggregated dataset.

In certain embodiments, a method is implemented on one or more processors. The method includes: receiving a first identifier, a second identifier, and a second public key from a shared resource; generating, by the one or more processors, a first public key and a first secret key; generating, by the one or more processors, a first one-time pad based on the first secret key, the first identifier, the second identifier, and the second public key; and masking, by the one or more processors, a first dataset using the first one-time pad.

In certain embodiments, a system for data masking and aggregation is disclosed. The system includes one or more memories storing instructions and one or more processors configured to execute the instructions to perform operations. The operations include: collecting a plurality of masked datasets each masked dataset associated with a one-time pad; and aggregating the plurality of masked datasets such that the one-time pads cancel each other to create an unmasked aggregated dataset.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1A is an example flow diagram depicting an illustrative method 100A of masking and aggregating data, in accordance with certain embodiments of the present disclosure.

FIG. 1B is an example flow diagram depicting an illustrative method 100B of masking and aggregating data, in accordance with certain embodiments of the present disclosure.

FIG. 2A depicts an illustrative system diagram of a data masking and aggregation system, in accordance with certain embodiments of the present disclosure.

FIG. 2B depicts an illustrative example of pairing participants/data providers computing shared keys without communication, in accordance with certain embodiments of the present disclosure

FIG. 3 shows illustrative examples of data masking using different masking schemes, in accordance with certain embodiments of the present disclosure.

While the disclosure is amenable to various modifications and alternative forms, specific embodiments have been shown by way of example in the drawings and are described in detail below. The intention, however, is not to limit the disclosure to the particular embodiments described but instead is intended to cover all modifications, equivalents, and alternatives falling within the scope the appended claims.

### DETAILED DESCRIPTION

As the terms are used herein with respect to measurements (e.g., dimensions, characteristics, attributes, components), and ranges thereof, of tangible things (e.g., products, inventory) and/or intangible things (e.g., data, electronic representations of currency, accounts, information, portions of things like percentages or fractions, calculations, data models, dynamic system models, algorithms, parameters), “about” and “approximately” may be used, interchangeably, to refer to a measurement that includes the stated measurement and that also includes any measurements that are reasonably close to the stated measurement, but that may differ by a reasonably small amount such as will be understood, and readily ascertained, by individuals having ordinary skill in the relevant arts to be attributable to measurement error; differences in measurement and/or manufacturing equipment calibration; human error in reading and/or setting measurements; adjustments made to optimize performance and/or structural parameters in view of other measurements (e.g., measurements associated with other things); particular implementation scenarios; imprecise adjustment and/or manipulation of things, settings, and/or measurements by a person, a computing device, and/or a machine; system tolerances; control loops; machine-learning; foreseeable variations (e.g., statistically insignificant variations, chaotic variations, system and/or model instabilities; preferences; and/or the like.

Although illustrative methods may be represented by one or more drawings (e.g., flow diagrams, communication flows), the drawings should not be interpreted as implying any requirement of, or particular order among or between, various steps disclosed herein. However, certain some embodiments may require certain steps and/or certain orders between certain steps, as may be explicitly described herein and/or as may be understood from the nature of the steps themselves (e.g., the performance of some steps may depend on the outcome of a previous step). Additionally, a “set,” “subset,” or “group” of items (e.g., inputs, algorithms, data values) may include one or more items, and, similarly, a subset or subgroup of items may include one or more items. A “plurality” means more than one.

As used herein, the term “based on” is not meant to be restrictive, but rather indicates that a determination, identification, prediction, calculation, and/or the like, is performed by using, at least, the term following “based on” as an input. For example, predicting an outcome based on a particular piece of information may additionally, or alternatively, base the same determination on another piece of information.

Data aggregation involves consolidating data contributed by different entities. Datasets are often deidentified, masked, or encrypted before aggregated. Although aggregated datasets are helpful for analytics, data security and privacy is a concern because the datasets can be re-identified and associated with the individual contributing entities. Additionally, aggregating masked or encrypted data may generate meaningless data, such that it is less useful for data analysis.

At least some embodiments of the present disclosure are directed to systems and methods of masking data such that aggregating the masked data can generate unmasked aggregated data. In some embodiments, one-time pads (OTPs) are used for masking or encryption, which can prevent masked/encrypted data from being re-identified. As used herein, a one-time pad refers to an encryption technique using a one-time key. Some embodiments of the present disclosure further uses a public and private/secret key pair to create the one-time pad. Additionally, in some cases, two sets of masked data, each from a respective data provider, using a common one-time pad can generate unmasked aggregated data. In one embodiment, the masking process is applying an arithmetic operation (e.g., add, subtract, multiply, divide) to the one-time key. In some cases, the one-time pads can use pseudorandom generator (PRG) to refresh one-time keys.

At least some embodiments of the present disclosure are directed to systems and methods of establish a unique shared key among a pair of data providers without communication between the pair of data providers. In some embodiments, a non-interactive key establishment (NIKE) primitive can be used. In some cases, a data provider can generate a first masked dataset using a first set of one-time pads for data aggregations at a first time; and generate a second masked dataset using a second set of one-time pads for data aggregations at a second time. In some cases, the first set of one-time pads are different from the second set of one-time pads. In some cases, the data provider uses a first PRG (PRG₁), or referred to as a PRG at a first state, at a first time to generate the first set of one-time pads and a second PRG (PRG₂), or referred to as a PRG at a second state, at a second time to generate the second set of one-time pads.

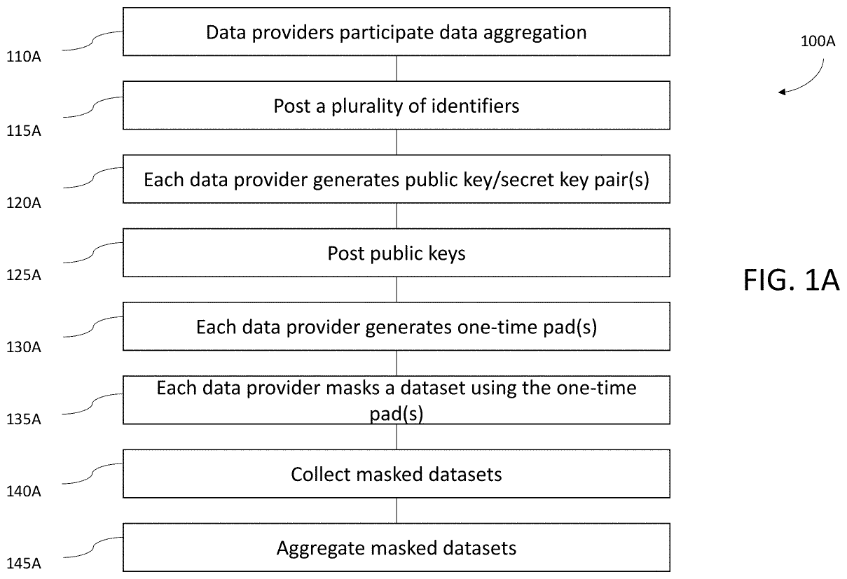

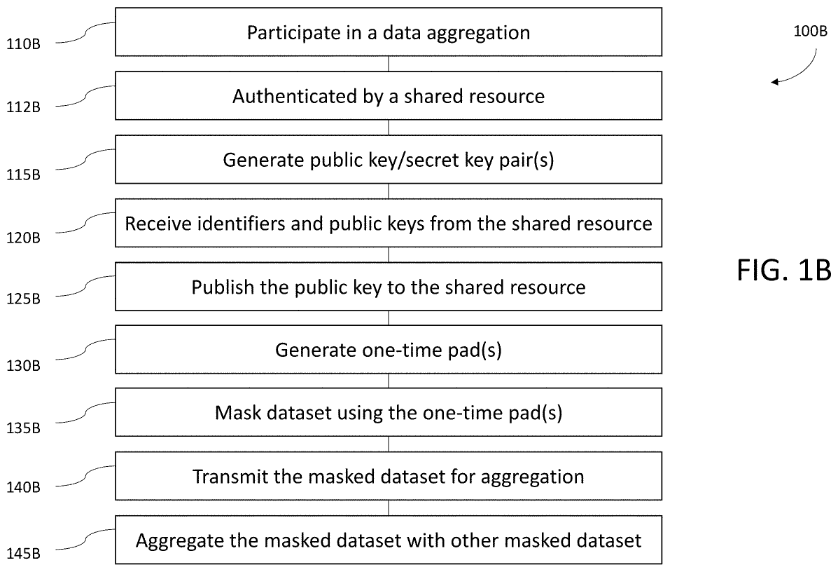

FIG. 1A is an example flow diagram depicting an illustrative method 100A of masking and aggregating data, in accordance with certain embodiments of the present disclosure. One or more steps of method 100A are optional and/or can be modified by one or more steps of other embodiments described herein. Additionally, one or more steps of other embodiments described herein may be added to the method 100A. Initially, a number of data providers, also referred to as participants, participate the data aggregation (110A). The aggregator or a third party posts a plurality of identifiers (115A) at a shared resource, also referred to as a bulletin board. In some implementations, the bulletin board requires authentications to access. In some cases, each of the plurality of identifiers is a unique identifier. In some embodiments, the data providers are arranged in a circle, such that the last data provider P_{N} is the predecessor of the first data provider P₁ and the first data provider P₁ is the successor of the last data provider P_{N}. In such embodiments, each data provider can have r predecessors and r successors, where r is less than the total number of participants.

In some embodiments, each data provider generates public key/secret key pair(s) (120A) and posts the public key (125A) to the bulletin board. In some embodiments, each data provider generates one-time pad(s) (130A). In some cases, a data masking configuration is selected such as, for example, selecting the number of one-time pads used to mask each dataset. In some embodiments, the number of one-time pads applied to each dataset is even. In some cases, each dataset is masked by a same number of one-time pads as each other. In one example, each data provider is paired with r predecessors and r successors. In one configuration, each data provider is paired with one (1) predecessor and one (1) successor. In some cases, each data provider generates the one-time pad based at least partially on a secret key (e.g., its own secret key). In some cases, each pair of data providers generate the same one-time pad using the symmetric NIKE algorithm.

In some cases, each data provider generates one-time pads according to the selected data masking configuration. In the example of one (1) predecessor and one (1) successor, each data provider generates a one-time pad with the predecessor and a one-time pad with the successor. In some embodiments, a data provider Pᵢ and its pairing data provider Pⱼ each generates a respective pairing one-time pad, m_{i,j} and m_{i,j}, and these two one-time pads are the same as each other. In one example, the pairs of one-time pad, m_{i,j} and m_{i,j}, are generated at least partially based on the other's public key and its own secret key. In some cases, the data providers use NIKE primitive to generate these common one-time pads. More details on NIKE primitive can be found, for example, in Whitfield D., Martin H. E., “New directions in cryptography,” IEEE Transactions on Information Theory 22(6) (1976) 644-654 and Freire E. S. V., Hofheinz D., Kiltz E., Paterson K. G., “Non-Interactive Key Exchange,” in Kurosawa K., Hanaoka G. (eds) Public-Key Cryptography—PKC 2013, Lecture Notes in Computer Science, vol 7778. Springer, Berlin, Heidelberg, which are incorporated herein by reference.

In some embodiments, each data provider masks a dataset using the one-time pad(s) (135A). In some cases, each data provider masks the dataset using a first operation to the predecessor one-time pads (i.e., a one-time pad generated with a pairing predecessor) and a second operation to the successor one-time pads (i.e., a one-time pad generated with a pairing predecessor). In one case, the first operation and the second operation are a pair of cancelling operations, where the first operation has an opposite effect to the second operation. For example, if a dataset is applied with the first operation with a variable followed by applying the second operation with the same variable, the dataset is unchanged. In one example, the first and second operations are respectively, for example, add/subtract, multiple/divide, and/or the like.

In some embodiments, a data aggregator collects a plurality of masked datasets (140A) and aggregates the collected masked datasets (145A) to create an unmasked aggregated dataset. In some cases, the data aggregation is a summation. In some cases, the data aggregation can use other data aggregation approaches, for example, weighted summation, average, variance, standard deviation, statistical aggregation, and/or the like. In some cases, the one-time pads applied to the dataset are cancelling each other during the data aggregation process. In one example, the pairing one-time pad is applied with a first operation in generating a first masked dataset and applied with a second operation in generating a second marked dataset, where the first operation and the second operation are a pair of cancelling operations.

FIG. 1B is an example flow diagram depicting an illustrative method 100B of masking and aggregating data, in accordance with certain embodiments of the present disclosure. One or more steps of method 100B are optional and/or can be modified by one or more steps of other embodiments described herein. Additionally, one or more steps of other embodiments described herein may be added to the method 100B. Initially, a data provider participates a data aggregation (110B), for example, with a group of data providers. In some embodiments, the data provider provides authentication information (e.g., login information) to be authenticated by a shared resource (e.g., a bulletin board) (112B). In some embodiments, the data provider generates one or more public key and secret key (i.e., private key) pairs (115B). The data provider receives a plurality of identifiers and public keys from the shared resource (120B), where the identifiers includes an identifier for the data provider itself. In some cases, based on the identifiers, the data provider identifies its predecessor(s) and successor(s).

In some cases, the data provider will retrieve a common key from the share resource that is used in the generation of the public key and secret key. In some cases, the common key is associated with a data masking configuration. In some cases, the common key is associated with its own identifier and the identifier of a pairing data provider (e.g., a predecessor or a successor).

In some embodiments, the data provider may publish the public key to the shared resource (125B). The data provider may generate one-time pad(s) (125B), using the identifiers, its own secret key(s), and public key(s). In some cases, the data provider generates shared key(s) with its pairing data provider(s) and the shared key(s) is(are) used to generate the one-time pad(s). As used herein, a shared key refers to a common key (e.g., data, token, etc.) that is a same key among two or more actors, while each actor may generate the shared key independently. In some cases, the data provider may apply a function to the shared key(s) to generate the one-time pad(s). In some cases, the function is a pseudorandom generator. In some cases, the function is changed over time, for example, to improve security of data masking scheme. In some cases, the function is a common function used by the group of data providers, such that a same one-time pad is generated using a shared key. As used herein, a one-time pad generated using data (e.g., identifier, public key) of a pairing data provider is referred to as a one-time pad paired with the pairing data provider. In some cases, the pairing data provider generates a same one-time pad using data of this data provider.

In some embodiments, the data provider masks a dataset using the one-time pad(s) (130B). In some cases, the data provider masks the dataset by applying one or more operations to the one-time pad(s). In one embodiment, the one or more operations include a pair of cancelling operations. In one embodiment, the one or more operations include a first operation and a second operation, for example, an addition operation and a subtraction operation. In some cases, the data provider applies a first operation to one-time pads paired with predecessor(s) and a second operation to one-time pads paired with successor(s). In one embodiment, the data provider has an equal number (e.g., 1, 2, 3) of predecessors and successors.

In some embodiments, the data provider transmits the masked dataset for aggregation (135B). In some embodiments, the aggregator aggregates the received masked dataset with other masked datasets (140B), for example, to generate an unmasked aggregated dataset. In some embodiments, other masked dataset is each generated using a same or similar process as described. In some cases, the one-time pads applied in the group of masked dataset cancel each other such that the aggregated dataset is unmasked. In one example, a first one-time pad is the same as a second one-time pad (e.g., generated by a pair of data providers), where masking a first dataset comprises masking the first dataset by applying a first operation to the first one-time pad and masking a second dataset comprises masking the second dataset by applying a second operation to the second one-time pad, and the first operation cancels the second operation. In some cases, in the data aggregation, each dataset is masked by a same number of one-time pads as each other.

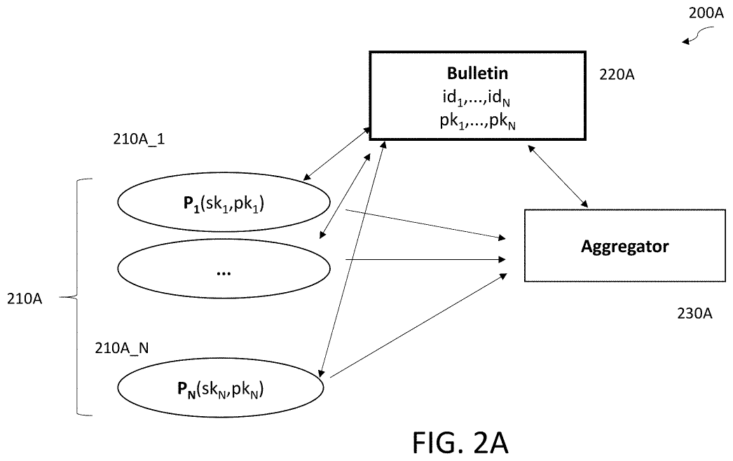

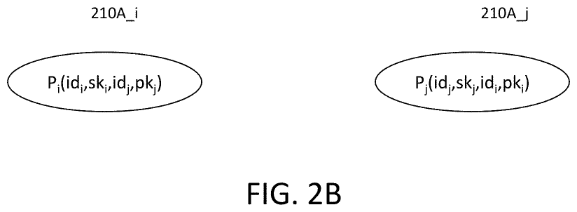

FIG. 2A depicts an illustrative system diagram of a data masking and aggregation system 200A, in accordance with certain embodiments of the present disclosure. The data masking and aggregation system 200A includes participants (or data providers) 210A, a bulletin board 220A, and an aggregator 230A. As used herein, a participant is also referred to as a data provider. The bulletin board 220A is a data sharing infrastructure. Each participant/data provider 210A (e.g., 210A_1, . . . 210A_N) generates a pair of secret key/public key (e.g., skᵢ/pkᵢ) and sends the public key (e.g., pkᵢ) to the bulletin board 220A. In some cases, the aggregator 230A generates a pair of secret key/public key to enable secure data transmissions. In some embodiments, the bulletin board 220A generates identifiers corresponding to all participants 210A joining the aggregation and publishes the identifiers. In some cases, each of the plurality of identifiers is a unique identifier (e.g., idᵢ).

In some embodiments, the bulletin board 220A includes a public-key infrastructure (PKI). In some cases, the bulletin board 220A can publish the public keys of the data providers. In some cases, the bulletin board 220A requires authentications to access. In some cases, the bulletin board 220A has authenticated channels among the participants 210A and the aggregator 230A. In some embodiments, the participants 210A identified by the bulletin board 220A can be arranged in a circle, for example, an order of (1, 2, . . . N, 1). In such embodiments, every participant Pᵢ(idᵢ) associated with the identifier idᵢ has a predecessor Pᵢ₋₁(idᵢ₋₁) and a successor Pᵢ₊₁(idᵢ₊₁). The successor of participant P_{N}(id_{N}) is P₁(id₁) and the predecessor of participant P₁(id₁) is P_{N}(id_{N}). In such embodiments, each data provider can have r predecessors and rsuccessors, where r is less than the total number of participants.

Each participant Pᵢ computes a shared key with each of one or more predecessors and each of the one or more successors. In some embodiments, the number of the predecessors/successors is determined by the selected data masking configuration. In some cases, these shared keys can be used as seeds in order to have updatable one-time pads (OTPs) to mask datasets. In some cases, the number of predecessors is equal to the number of successors. In some embodiments, the data providers are arranged in a circle, such that the last data provider P_{N} is the predecessor of the first data provider P₁ and the first data provider P₁ is the successor of the last data provider P_{N}.

In some embodiments, each data provider 210A generates public key/secret key and posts the public key to the bulletin board 220B. In some cases, the public key and secret key pair is generated using a common key retrieved from the bulletin board 220A. In some cases, a data masking configuration such as, for example, the number of one-time pads used to mask each dataset, is selected. In one example, each data provider 210A is paired with r predecessors (e.g., Pᵢ₋₁, Pᵢ₋₂, . . . , Pᵢ₋ᵣ) and r successors (e.g., Pᵢ₊₁, Pᵢ₊₂, . . . , Pᵢ₊ᵣ). In one example, each data provider is paired with one (1) predecessor and one (1) successor. In some embodiments, each data provider 210A generates one-time pad(s). In some cases, each data provider 210A generates the one-time pad based at least partially on a secret key of its own. In some cases, the one-time pad for each participant pair is determined based at least partially on at least two of the plurality of identifiers. In some cases, the one-time pad for each participant pair is determined based at least partially on one of the plurality of public keys (e.g., the public key of the paired participant).

In some embodiments, each masked dataset is associated with a first set of one-time pads each applied with a first operation and a second set of one-time pads each applied with a second operation, where the first set of one-time pads and the second set of one-time pads are equal in cardinality. In some cases, each data provider 210A generates one-time pads according to the selected data masking configuration. In the example of each data provider having one (1) predecessor and one (1) successor, each data provider 210A generates a one-time pad with the predecessor and a one-time pad with the successor. In some embodiments, a data provider Pᵢ and its pairing data provider Pⱼ each generates a respective pairing one-time pad, m_{i,j} and m_{i,j}, and these two one-time pads are the same as each other. In one example, the pairing one-time pads, m_{i,j} and m_{i,j}, are generated using the other's public key. In one example, the pairing one-time pads, m_{i,j} and m_{i,j}, are generated using its own secret key. In some cases, the data providers 210A use NIKE primitive to generate these pairing one-time pads. In some cases, the data providers 210A use NIKE primitive to generate shared keys between pairing data providers and generate the one-time pads using a function (e.g., PRG function) applied to the shared keys.

In some embodiments, each data provider 210A masks a dataset using one or more one-time pad(s). In some cases, each data provider 210A masks the dataset using a first operation to the predecessor one-time pads (i.e., one-time pad pairing with a predecessor) and a second operation to the successor one-time pads (i.e., one-time pad pairing with a successor). In one cases, the first operation and the second operation are a pair of cancelling operations. For example, if a dataset is applied with the first operation using a variable followed by being applied with the second operation using the same variable, the dataset is unchanged. In one example, the first and second operations are respectively, for example, add/subtract, multiple/divide, and/or the like.

In some embodiments, an aggregator 230A collects a plurality of masked datasets from the data providers 210A and aggregates the collected masked datasets to create an unmasked aggregated dataset. In some cases, the data aggregation is a summation. In some cases, the data aggregation can use other data aggregation approach, for example, weighted summation, average, variance, standard deviation, statistical aggregation, and/or the like. In some cases, the one-time pads are cancelling each other during the data aggregation process. In one example, the pairing one-time pad is applied with a first operation in generating a first masked dataset and applied with a second operation in generating a second marked dataset, where the first operation and the second operation are cancelling each other.

In some embodiments, each of the participants/data providers 210A, the bulletin board 220A and the aggregator 230A is implemented on a computing device. In some embodiments, a computing device includes a bus that, directly and/or indirectly, couples the following devices: a processor, a memory, an input/output (I/O) port, an I/O component, and a power supply. Any number of additional components, different components, and/or combinations of components may also be included in the computing device. The bus represents what may be one or more busses (such as, for example, an address bus, data bus, or combination thereof). Similarly, in some embodiments, the computing device may include a number of processors, a number of memory components, a number of I/O ports, a number of I/O components, and/or a number of power supplies. Additionally, any number of the components (e.g., the participants 210A, the bulletin board 220A, the aggregator 230A) of the data masking and aggregation system 200A, or combinations thereof, may be distributed and/or duplicated across a number of computing devices.

In some embodiments, the memory of the computing device includes computer-readable media in the form of volatile and/or nonvolatile memory, transitory and/or non-transitory storage media and may be removable, nonremovable, or a combination thereof. Media examples include Random Access Memory (RAM); Read Only Memory (ROM); Electronically Erasable Programmable Read Only Memory (EEPROM); flash memory; optical or holographic media; magnetic cassettes, magnetic tape, magnetic disk storage or other magnetic storage devices; data transmissions; and/or any other medium that can be used to store information and can be accessed by a computing device such as, for example, quantum state memory, and/or the like. In some embodiments, the memory stores computer-executable instructions for causing a processor (e.g., the participant 210A, the bulletin board 220A, and/or the aggregator 230A) to implement aspects of embodiments of system components discussed herein and/or to perform aspects of embodiments of methods and procedures discussed herein.

Computer-executable instructions may include, for example, computer code, machine-useable instructions, and the like such as, for example, program components capable of being executed by one or more processors associated with a computing device. Program components may be programmed using any number of different programming environments, including various languages, development kits, frameworks, and/or the like. Some or all of the functionality contemplated herein may also, or alternatively, be implemented in hardware and/or firmware.

In some embodiments, the memory includes a data repository, for example, to store original dataset, masked dataset, one-time pads, shared keys, public keys, secret keys, identifiers, aggregated datasets, and/or the like. The data repository may be implemented using any one of the configurations described below. A data repository may include random access memories, flat files, XML files, and/or one or more database management systems (DBMS) executing on one or more database servers or a data center. A database management system may be a relational (RDBMS), hierarchical (HDBMS), multidimensional (MDBMS), object oriented (ODBMS or OODBMS) or object relational (ORDBMS) database management system, and the like. The data repository may be, for example, a single relational database. In some cases, the data repository may include a plurality of databases that can exchange and aggregate data by data integration process or software application. In an exemplary embodiment, at least part of the data repository may be hosted in a cloud data center. In some cases, a data repository may be hosted on a single computer, a server, a storage device, a cloud server, or the like. In some other cases, a data repository may be hosted on a series of networked computers, servers, or devices. In some cases, a data repository may be hosted on tiers of data storage devices including local, regional, and central.

Various components of the aggregation system 200A can communicate via or be coupled to via a communication interface, for example, a wired or wireless interface. The communication interface includes, but is not limited to, any wired or wireless short-range and long-range communication interfaces. The wired interface can use cables, wires, and/or the like. The short-range communication interfaces may be, for example, local area network (LAN), interfaces conforming known communications standard, such as Bluetooth® standard, IEEE 802 standards (e.g., IEEE 802.11), a ZigBee® or similar specification, such as those based on the IEEE 802.15.4 standard, or other public or proprietary wireless protocol. The long-range communication interfaces may be, for example, wide area network (WAN), cellular network interfaces, satellite communication interfaces, etc. The communication interface may be either within a private computer network, such as intranet, or on a public computer network, such as the internet.

FIG. 2B depicts an illustrative example of pairing participants/data providers (e.g., a data provider with a predecessor, or a data provider with a successor) computing shared keys without communication, in accordance with certain embodiments of the present disclosure. In this example, a hash function H( ) is used. Additionally, the hash function H( ) uses the inputs of identifiers, public key, and secret key to generate the shared keys. As illustrated, the participant Pᵢ 210A_i has the information of its own identifier idᵢ, and secret key skᵢ, the identifier idⱼ and the public key pkⱼ of a pairing participant Pᵢ 210A_j. In one example, if i<j, the shared key can be calculated using equation (1) below:

S_{i,j}=H(idᵢ, idⱼ, pkⱼ^{sk}^{ᵢ}) (1),

where S_{i, j} is the shared key, H( ) is the hash function, idᵢ is the identifier of the participant Pᵢ, idⱼ is the identifier of the participant Pⱼ, skᵢ is the secret key of the participant Pᵢ, and pkᵢ is the public key of the participant Pⱼ. In this example, if i>j, the shared key can be calculated using equation (2) below:

S_{i,j}=H(idⱼ, idᵢ, pkⱼ^{sk}^{ᵢ}) (2),

where S_{i,j} is the shared key, H( ) is the hash function, idᵢ is the identifier of the participant Pᵢ, idⱼ is the identifier of the participant Pⱼ, skᵢ is the secret key of the participant Pⱼ, and pkᵢ is the public key of the participant Pⱼ.

In one example, the participant Pᵢ 210A_j has the information of its own identifier idⱼ, and secret key skⱼ, the identifier idᵢ and the public key pkᵢ of the pairing participant Pᵢ 210A_i. In one example, if j<i, the shared key can be calculated using equation (3) below:

S_{j,i}=H(idⱼ, idᵢ, pkᵢ^{sk}^{ⱼ}) (3),

where S_{j,i} is the shared key, H( ) is the hash function, idᵢ is the identifier of the participant Pᵢ, id ⱼ is the identifier of the participant Pⱼ, skⱼ is the secret key of the participant Pⱼ, and pkᵢ is the public key of the participant Pᵢ. In this example, if j>i, the shared key can be calculated using equation (4) below:

S_{j,i}=H(idⱼ, idⱼ, pkᵢ^{sk}^{ⱼ}) (4),

where S_{j,i} is the shared key, H( ) is the hash function, idᵢ is the identifier of the participant Pᵢ, idⱼ is the identifier of the participant Pⱼ, skⱼ is the secret key of the participant Pⱼ, and pkᵢ is the public key of the participant Pᵢ.

In one example, the secret key and the public key pair has the attribute illustrated in equation (5):

pkᵢ^{sk}=pkⱼ^{sk}^{ᵢ} (5),

where skᵢ is the secret key of the participant Pᵢ, pkᵢ is the public key of the participant Pⱼ, skⱼ is the secret key of the participant Pⱼ, and pk₁ is the public key of the participant Pⱼ. In this example, the shared key S_{i,j} calculated by participant Pᵢ is the same value as the shared key S_{j,i} calculated by participant Pⱼ independently.

In some embodiments, each participant uses the shared keys with predecessor(s) and successor(s) to generate one-time pads. In one example, the one-time pad is generated using equation (6) below:

m_{i,j}=fₜ(S_{i,j}) (6),

where m_{i,j} is the one-time pad for the pair of participants Pᵢ and Pⱼ, S_{i,j} is the shared key, and fₜ( ) is a function at time or instance t. In some embodiments, the function fₜ( ) is a same function used by various participants at time or instance t. In some embodiments, the function fₜ( ) is a different function at different times or instances, such as fₜ₁( ) is different from fₜ₂( ) where t1 is different from t2. In some cases, the function fₜ( ) is a pseudo random generator (PRG) using a seed value to generate a pseudorandom number. In one example, for a participant Pᵢ having a dataset Xᵢ, using a configuration of r predecessors and rsuccessors, the dataset Xᵢ is masked using equation (7):

x′i=xᵢ-m_{i,i}−1. . . m_{i,i_r}+m_{i, i}+1+ . . . +m_{i, i}+r (7),

where Xᵢ is the input data, X′ᵢ is masked data, m_{i, j} is the one-time pad for the pair of participants Pᵢ and Pⱼ. In this example, the input data is masked by subtracting the pairing predecessor one-time pads shared and adding the pairing successor one-time pads. Other calculation schemes to generate the masked datasets can be used.

In some embodiments, each participant Pᵢ 210A generates its respective masked dataset X′ᵢ and sends the masked dataset to the aggregator 230A. The aggregator uses the received masked dataset to generate aggregated data Agg_X. In some cases, each participant Pᵢ generates its respective masked dataset X′ᵢₜ at time or instance t and sends the masked dataset X′ᵢₜ to the aggregator to generate aggregated data Agg_Xₜ at time or instance t. In one embodiment, the one-time pads used by participants remain the same over a period of time or at multiple instances. In one embodiment, the one-time pads used by participants change by time or instance. In some cases, the one-time pads change by time or instance by using a pseudorandom generator. In one example, the data aggregation is a summation of masked datasets. Other data aggregation schemes can also be used.

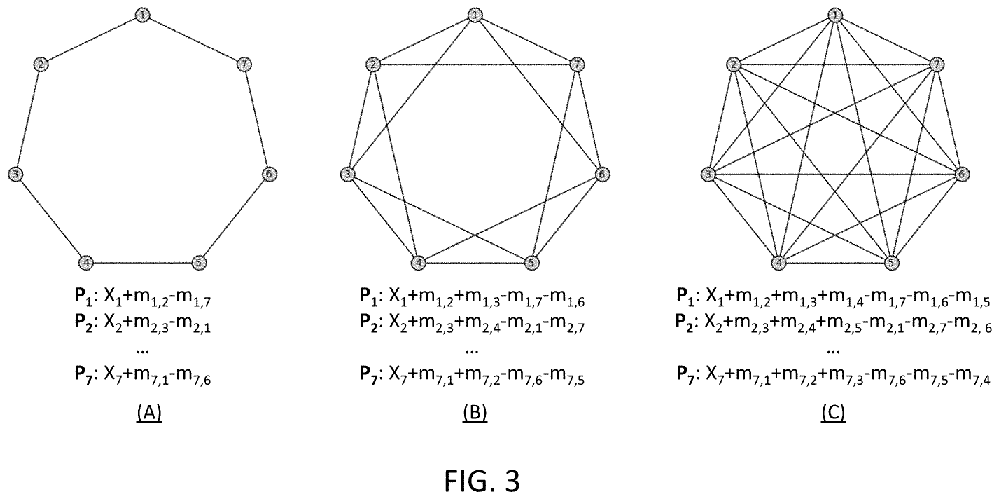

FIG. 3 shows illustrative examples of data masking using different masking schemes, in accordance with certain embodiments of the present disclosure. In these examples, there are 7 data providers/participants. The masking scheme (A) uses r predecessor(s) and r successor(s), where r=1. Using this scheme, the aggregator can determine the unmasked dataset Xᵢ of participant Pᵢ if both the predecessor Pᵢ₋₁ and successor Pᵢ₊₁ provide its own secret keys to the aggregator. In one example, this masking scheme can be used for participants being trusted, as this masking scheme has some security/privacy protection. The masking scheme (B) uses r predecessor(s) and r successor(s), where r=2. Using this scheme, the aggregator can determine the unmasked data Xᵢ of participant Pᵢ if all the predecessor Pᵢ₋₁, Pᵢ₋₂ and successors Pᵢ₊₁, Pᵢ₊₂ provide its own secret keys to the aggregator. In one example, this masking scheme can be used for majority participants being trusted, where this masking scheme (B) has stronger security/privacy protection than the masking scheme (A).

The masking scheme (C) uses r predecessor(s) and r successor(s), where r=3. Using this scheme, the aggregator can determine the unmasked data Xᵢ of participant Pᵢ if the predecessors Pᵢ₋₁, Pᵢ₋₂, Pᵢ₋₃ and the successors Pᵢ₊₁, Pᵢ₊₂, Pᵢ₊₃ provide secret keys to the aggregator. In one example, this masking scheme can be used in the case of majority participants being untrusted, where this masking scheme (B) has stronger security/privacy protection than the masking scheme (A).

Various modifications and additions can be made to the embodiments disclosed without departing from the scope of this disclosure. For example, while the embodiments described above refer to particular features, the scope of this disclosure also includes embodiments having different combinations of features and embodiments that do not include all of the described features. Accordingly, the scope of the present disclosure is intended to include all such alternatives, modifications, and variations as falling within the scope of the claims, together with all equivalents thereof.

I claim:

1. A method comprising:
collecting a plurality of masked datasets, each masked dataset associated with a respective one-time pad; and
aggregating the plurality of masked datasets such that the one-time pads cancel each other to create an unmasked aggregated dataset.

2. The method of claim 1, wherein each masked dataset of the plurality of masked datasets is associated with two or more one-time pads.

3. The method of claim 1, wherein a first masked dataset of the plurality of masked datasets is associated with a same number of one-time pads as a second masked dataset of the plurality of masked datasets.

4. The method of claim 1, further comprising:
posting a plurality of identifiers on a shared resource, each identifier being associated with a respective masked dataset of the plurality of masked datasets,
wherein the one-time pad for each masked dataset is determined based on at least two of the plurality of identifiers.

5. The method of claim 4, further comprising:
receiving a plurality of public keys from the shared resource, each public key being associated with a respective masked dataset of the plurality of masked datasets,
wherein the one-time pad for each masked dataset is further determined based on one of the plurality of public keys.

6. The method of claim 5, wherein the one-time pad for each masked dataset is further determined based on a secret key associated with a respective masked dataset.

7. A method implemented on one or more processors, comprising:
receiving a first identifier, a second identifier, and a second public key from a shared resource;
generating, by the one or more processors, a first public key and a first secret key;
generating, by the one or more processors, a first one-time pad based on the first secret key, the first identifier, the second identifier, and the second public key; and
masking, by the one or more processors, a first dataset using the first one-time pad.

8. The method of claim 7, further comprising:
sharing the first public key on the shared resource.

9. The method of claim 7, wherein the first one-time pad is generated using a pseudo random generator.

10. The method of claim 7, wherein the first identifier and the first public key are associated with a first data provider, and wherein the second identifier and the second public key are associated with a second data provider.

11. The method of claim 10, further comprising:
generating, by the one or more processors, a second one-time pad based on the first identifier, the second identifier, the first public key and a second secret key associated with the second data provider; and
masking, by the one or more processors, a second dataset using the second one-time pad.

12. The method of claim 11, wherein the first one-time pad is the same as the second one-time pad, wherein masking a first dataset comprises masking the first dataset by applying a first operation to the first one-time pad, wherein masking a second dataset comprises masking the second dataset by applying a second operation to the second one-time pad, and wherein the first operation and the second operation are a pair of cancelling operations.

13. The method of claim 12, further comprising:
aggregating, by the one or more processors, the first masked dataset and the second masked dataset to create an unmasked aggregated dataset.

14. A system comprising:
one or more memories storing instructions; and
one or more processors configured to execute the instructions to perform operations comprising:
collecting a plurality of masked datasets each masked dataset associated with a one-time pad, and
aggregating the plurality of masked datasets such that the one-time pads cancel each other to create an unmasked aggregated dataset.

15. The system of claim 14, wherein each masked dataset of the plurality of masked datasets is associated with two or more one-time pads.

16. The system of claim 14, wherein a first masked dataset of the plurality of masked datasets is associated with a same number of one-time pads as a second masked dataset of the plurality of masked datasets.

17. The system of claim 14, wherein the operations further comprise:
posting a plurality of identifiers on a shared resource, each identifier being associated with a respective masked dataset of the plurality of masked datasets,
wherein the one-time pad for each masked dataset is determined based on at least two of the plurality of identifiers.

18. The system of claim 17, wherein the operations further comprise:
receiving a plurality of public keys from the shared resource, each public key being associated with a respective masked dataset of the plurality of masked datasets,
wherein the one-time pad for each masked dataset is further determined based on one of the plurality of public keys.

19. The system of claim 18, wherein the one-time pad for each masked dataset is further determined based on a secret key associated with a respective masked dataset.

20. The system of claim 18, wherein each masked dataset is associated with a first set of one-time pads applied with a first operation and a second set of one-time pads applied with a second operation, and wherein the first set of one-time pads and the second set of one-time pads are equal in cardinality.
